(19) United States
(12) Patent Application Publication
(10) Pub. No.: US 2016/0333213 A1
(43) Pub. Date: Nov. 17, 2016

(54) DISPERSING AIDS OR BLENDS THEREOF TO PREPARE UNIVERSAL COLORANTS FOR AQUEOUS AND NON-AQUEOUS PAINTS AND COATING

(71) Applicant: RHODIA OPERATIONS, Paris (FR)

(72) Inventors: Lichang ZHOU, Lawrenceville, NJ (US); John HUGHES, Lincoln University, PA (US); Derek PAKENHAM, Hamilton, NJ (US)

(73) Assignee: RHODIA OPERATIONS, Paris (FR)

(21) Appl. No.: 15/152,761

(22) Filed: May 12, 2016

Related U.S. Application Data
(60) Provisional application No. 62/160,094, filed on May 12, 2015.

(51) Int. Cl. C09D 133/04

(52) U.S. Cl. CPC C09D 133/04

(57) ABSTRACT

Disclosed are novel dispersants for universal colorant systems, novel colorant systems and related method of preparing said systems. Also disclosed are methods of dispersing at least one pigment to prepare a universal colorant system, as well as methods for preparing coatings and paints utilizing the disclosed colorant systems.

### CROSS-REFERENCE TO RELATED APPLICATIONS

This application claims the benefit of U.S. Provisional Patent Application No. 62/160,094 filed May 12, 2015, incorporated herein by reference in its entirety.

### FIELD OF THE INVENTION

The present invention relates to novel dispersing aids or blends thereof, as well as compositions and methods for utilizing these dispersants or blends in various paint and coatings applications.

### BACKGROUND OF THE INVENTION

Colorants, typically, are compositions of pigment, dispersants, carrier/solvents, and other components, which are used to add color, via pigments, to tint-based paint systems usually at the point-of-sale. Pigments are typically organic or inorganic dry powders that incorporate a mixture of primary particles, aggregates and agglomerates, which must be wetted in the carrier or solvent. Dispersants are widely used in coating industries to disperse colorants, including inorganic or organic pigments. Dispersants can be divided to small molecules and polymers with varied chemistries. Most widely used polymeric dispersants are based on acrylic acid homopolymer or copolymers. The current state-of-the art systems use polymeric dispersants specific for the system used, or through dispersants that can be used in both solvent-borne and water-borne systems (hereafter referred to as universal dispersants), but that are used with solvents (like acetates or ketones) that can be miscible in both types of paints. For the universal colorants currently on the market, they face drawbacks in that they typically have a high level of solvents added that contribute significantly to a paint's overall VOC content. However, in the current regulatory environment, the paint formulators are trying to reduce the VOC contents in new paints to a near zero level. Current commercial dispersants, however, contain only 50% active and use solvents to reduce the actives level.

Some colorants contain VOCs (volatile organic compounds) that can directly influence the total VOCs contained in a paint or coating. With VOC regulations enforcing lower limits, paint formulators currently have a difficult time meeting regulations when using traditional universal colorants.

### SUMMARY OF THE INVENTION

In one aspect, disclosed are dispersant aids or blends thereof for use in colorant dispersions. In another aspect, disclosed are universal colorant systems for low VOC paint and coatings formulations comprising: (i) pigment, (ii) the dispersing aid or dispersant system described herein and (iii), optionally, a carrier. Typically, the universal colorant system (herein otherwise used interchangeably with “liquid colorant compositions”) is in liquid form and, in another embodiment, at least one dispersant is used as both a dispersant and carrier. In another aspect, disclosed are methods for preparing said colorant systems. In yet another aspect, disclosed are paints or coatings containing said colorant systems. In one embodiment, the paints are solvent-borne (e.g., alkyd) and/or waterborne base paints, which contain low amounts of or are substantially free of volatile organic compounds. In a further aspect, disclosed are methods for preparing said paints or coatings.

The present invention includes compositions such as liquid dispersions comprising universal colorant systems, which comprise the dispersing aids or blends, as described herein. In particular the invention is also directed using the universal colorant system in low VOC paint and coatings applications.

The dispersant aids or dispersant blends, in another embodiment, are components or additives for latex binders, paints and aqueous coatings, typically as to aid in dispersing generally hydrophobic compounds such as pigments and the like. The aqueous coating compositions as described herein typically include at least one latex polymer derived from at least one monomer, for example acrylic monomers. The at least one latex polymer in the aqueous coating composition can be a pure acrylic, a styrene acrylic, a vinyl acrylic or an acrylated ethylene vinyl acetate copolymer and is more preferably a pure acrylic. The at least one latex polymer is preferably derived from at least one acrylic monomer selected from the group consisting of acrylic acid, acrylic acid esters, methacrylic acid, and methacrylic acid esters. For example, the at least one latex polymer can be a butyl acrylate/methyl methacrylate copolymer or a 2-ethylhexyl acrylate/methyl methacrylate copolymer. Typically, the at least one latex polymer is further derived from one or more monomers selected from the group consisting of styrene, alpha-methyl styrene, vinyl chloride, acrylonitrile, methacrylonitrile, ureido methacrylate, vinyl acetate, vinyl esters of branched tertiary monocarboxylic acids, itaconic acid, crotonic acid, maleic acid, fumaric acid, ethylene, and C₄-C₈ conjugated dienes.

Latex paint formulations typically comprise additives, e.g., at least one pigment. In a preferred embodiment of the invention the latex paint formulation includes at least one pigment selected from the group consisting of TiO2, CaCO3, clay, aluminum oxide, silicon dioxide, magnesium oxide, sodium oxide, potassium oxide, talc, barytes, zinc oxide, zinc sulfite and mixtures thereof.

In addition to the above components, the colorant systems and/or aqueous coating compositions as described herein can include one or more additives selected from the group consisting of dispersants, surfactants, rheology modifiers, defoamers, thickeners, biocides, mildewcides, colorants, waxes, perfumes and co-solvents.

Compositions of the present invention may have an absence of one or more of anionic surfactant, cationic surfactant, nonionic surfactant, zwitterionic surfactant, and/or amphoteric surfactant.

As described herein, dispersing aids or dispersant blends to make universal colorant systems can be used in aqueous and non-aqueous solutions (from low polarity to high polarity solvents) that are up to 100% active with low/no VOCs. In one embodiment, the dispersing aids are up to 90% active with low/no VOCs. In one embodiment, the dispersing aids are up to 80% active with low/no VOCs. In one embodiment, the dispersing aids are up to 60% active with low/no VOCs. In one embodiment, the dispersing aids are up to 95% active with low/no VOCs. In one embodiment, the dispersing aids are up to 98% active with low/no VOCs. In one embodiment, the dispersing aids are up to 99% active with low/no VOCs. In one embodiment, the dispersing aids are up to 93% active with low/no VOCs. In one embodiment, the dispersing aids are up to 96% active with low/no VOCs

Low VOC (Volatile Organic Content) in some embodiments mean a VOC level of less than about 100 g/L, or less than or equal to about 90 g/L, or less than or equal to about 80 g/L, or less than or equal to about 70 g/L, or less than or equal to about 60 g/L, or less than or equal to about 50 g/L, or less than or equal to about 40 g/L. No VOC means, in some embodiments, means having no added VOC compounds. In another embodiment, “no VOC” means having only minimal (trace) amounts of VOC amounting to less than or equal to 1 g/L or, in other embodiments, less than or equal to 0.5 g/L, less than or equal to 0.3 g/L, less than or equal to 0.2 g/L, less than or equal to 0.1 g/L, or less than or equal to 0.05 g/L.

The new universal colorant based on the new developed dispersing system can allow paint formulators to meet the more stringent VOC requirements without issues. The new dispersing aids include alkoxylated mono or multifunctional materials, such as EO/PO type surfactant or oligomer, or their blends, or their blends with other liquid or solid of low to high molecular weight dispersing aids. In one embodiment, one example of the new dispersing aid is a 50/50 blend of Antarox BL-225 (EO/PO surfactant) and Antarox RA-40 (EO/PO surfactant) along with 20% weight addition of Sopophor S-25 (Tristyrylphenol ethoxylate) to help with dispersing the various pigments. There is no additional water or solvent added to the new universal colorant, so it can easily be used in both solvent-based and aqueous paint formulations. The Antarox blend can be used by itself, or mixed with a dispersant, such as the Sopophor S-25, Sopophor S-40 or a polymeric dispersant to improve long term stability. Other types of alkoxylated materials include trifunctional materials such as EO/PO derivatives from trimethylolpropane or glycerol, tetrafunctional materials such as EO/PO derivatives from pentaerythritol.

In another aspect, described herein are methods for dispersing pigments in an aqueous emulsion, comprising: contacting (i) an aqueous emulsion containing at least one pigment with (ii) the polymeric dispersant copolymer or homopolymer as described herein.

These and other features and advantages of the present invention will become more readily apparent to those skilled in the art upon consideration of the following detailed description, which describe both the preferred and alternative embodiments of the present invention.

### DETAILED DESCRIPTION OF THE PREFERRED EMBODIMENTS

The present invention relates to, in one embodiment, the use of a particular family of dispersant copolymers for latex dispersions, binders, as well as for solvent-borne (e.g., alkyd) and/or waterborne base paints and coatings. Described herein are aqueous compositions, for example, aqueous coating compositions. The aqueous compositions are, in one embodiment, aqueous polymer dispersions which include at least one latex polymer. Paints or other aqueous coatings of the present invention typically further include at least one pigment. In another embodiment, the latex has a Tg of less than 30° C., more typically less than 20° C., still more typically in the range from 10 to −10° C., e.g., 0° C. In one embodiment, the latex has a Tg of less than 10° C., more typically less than 5° C., still more typically in the range from 5 to −10° C., e.g., 0° C.

As used herein, the term “alkyl” means a monovalent straight or branched saturated hydrocarbon radical, more typically, a monovalent straight or branched saturated (C₁-C₄₀) hydrocarbon radical, such as, for example, methyl, ethyl, n-propyl, isopropyl, n-butyl, isobutyl, tert-butyl, hexyl, octyl, hexadecyl, octadecyl, eicosyl, behenyl, tricontyl, and tetracontyl.

As used herein, the term “alkenyl” means an unsaturated straight or branched hydrocarbon radical, more typically an unsaturated straight, branched, (C₂-C₂₂) hydrocarbon radical, that contains one or more carbon-carbon double bonds, such as, for example, ethenyl, n-propenyl, iso-propenyl.

As used herein, the term “alkoxyl” means an oxy radical that is substituted with an alkyl group, such as for example, methoxyl, ethoxyl, propoxyl, isopropoxyl, or butoxyl, which may optionally be further substituted on one or more of the carbon atoms of the radical.

As used herein, the term “alkoxyalkyl” means an alkyl radical that is substituted with one or more alkoxy substituents, more typically a (C₁-C₂₂)alkyloxy-(C₁-C₆)alkyl radical, such as methoxymethyl, and ethoxybutyl.

As used herein, terms “aqueous medium” and “aqueous media” are used herein to refer to any liquid medium of which water is a major component. Thus, the term includes water per se as well as aqueous solutions and dispersions.

As used herein, the term “aryl” means a monovalent unsaturated hydrocarbon radical containing one or more six-membered carbon rings in which the unsaturation may be represented by three conjugated double bonds, which may be substituted one or more of carbons of the ring with hydroxy, alkyl, alkoxyl, alkenyl, halo, haloalkyl, monocyclic aryl, or amino, such as, for example, phenyl, methylphenyl, methoxyphenyl, dimethylphenyl, trimethylphenyl, chlorophenyl, trichloromethylphenyl, triisobutyl phenyl, tristyrylphenyl, and aminophenyl.

As used herein, the term “arylalkyl” means an alkyl group substituted with one or more aryl groups, more typically a (C₁-C₁₈)alkyl substituted with one or more (C₆-C₁₄)aryl substituents, such as, for example, phenylmethyl, phenylethyl, and triphenylmethyl.

As used herein, the term “aryloxy” means an oxy radical substituted with an aryl group, such as for example, phenyloxy, methylphenyl oxy, isopropylmethylphenyloxy.

As used herein, the terminology “(Cₓ-C_{y})” in reference to an organic group, wherein x and y are each integers, indicates that the group may contain from x carbon atoms to y carbon atoms per group.

As used herein, the term “cycloalkenyl” means an unsaturated hydrocarbon radical, typically an unsaturated (C₅-C₂₂) hydrocarbon radical, that contains one or more cyclic alkenyl rings and which may optionally be substituted on one or more carbon atoms of the ring with one or two (C₁-C₆)alkyl groups per carbon atom, such as cyclohexenyl, cycloheptenyl, and “bicycloalkenyl” means a cycloalkenyl ring system that comprises two condensed rings, such as bicycloheptenyl.

As used herein, the term “cycloalkyl” means a saturated hydrocarbon radical, more typically a saturated (C₅-C₂₂) hydrocarbon radical, that includes one or more cyclic alkyl rings, which may optionally be substituted on one or more carbon atoms of the ring with one or two (C₁-C₆)alkyl groups per carbon atom, such as, for example, cyclopentyl, cycloheptyl, cyclooctyl, and “bicyloalkyl” means a cycloalkyl ring system that comprises two condensed rings, such as bicycloheptyl.

As used herein, an indication that a composition is “free” of a specific material means the composition contains no measurable amount, or trace amounts (e.g., less than 0.1% by weight), of that material.

As used herein, the term “heterocyclic” means a saturated or unsaturated organic radical that comprises a ring or condensed ring system, typically comprising from 4 to 16 ring atoms per ring or ring system, wherein such ring atoms comprise carbon atoms and at least one heteroatom, such as for example, O, N, S, or P per ring or ring system, which may optionally be substituted on one or more of the ring atoms, such as, for example, thiophenyl, benzothiphenyl, thianthrenyl, pyranyl, benzofuranyl, xanthenyl, pyrolidinyl, pyrrolyl, pyradinyl, pyrazinyl, pyrimadinyl, pyridazinyl, indolyl, quinonyl, carbazolyl, phenathrolinyl, thiazolyl, oxazolyl, phenoxazinyl, or phosphabenzenyl.

As used herein, the term “hydroxyalkyl” means an alkyl radical, more typically a (C₁-C₂₂)alkyl radical, that is substituted with one or more hydroxyl groups, such as for example, hydroxymethyl, hydroxyethyl, hydroxypropyl, and hydroxydecyl.

As used herein the term “(meth)acrylate” refers collectively and alternatively to the acrylate and methacrylate and the term “(meth)acrylamide” refers collectively and alternatively to the acrylamide and methacrylamide, so that, for example, “butyl (meth)acrylate” means butyl acrylate and/or butyl methacrylate.

As used herein, “molecular weight” in reference to a polymer or any portion thereof, means to the weight-average molecular weight (“M_{w}”) of the polymer or portion. M_{w} of a polymer is a value measured by gel permeation chromatography (GPC) with an aqueous eluent or an organic eluent (for example dimethylacetamide, dimethylformamide, and the like), depending on the composition of the polymer, light scattering (DLS or alternatively MALLS), viscometry, or a number of other standard techniques. M_{w} of a portion of a polymer is a value calculated according to known techniques from the amounts of monomers, polymers, initiators and/or transfer agents used to make the portion.

In one embodiment, the dispersant compositions as described exhibit a weight average molecular weight, as determined by gel permeation chromatography (GPC) and light scattering of a solution of polymer in tetrahydrofuran and compared to a polystyrene standard, of between 100 to 50,000 grams per mole (“g/mole”). In another embodiment, the polymers for use in the present invention exhibit a weight average molecular weight 200 to 25,000 grams per mole (“g/mole”). In yet another embodiment, the polymers for use in the present invention exhibit a weight average molecular weight 200 to 15,000 grams per mole (“g/mole”). In yet another embodiment, the polymers for use in the present invention exhibit a weight average molecular weight 200 to 5,000 grams per mole (“g/mole”). In yet another embodiment, the polymers for use in the present invention exhibit a weight average molecular weight 300 to 5,000 grams per mole (“g/mole”). In yet another embodiment, the polymers for use in the present invention exhibit a weight average molecular weight 300 to 2,000 grams per mole (“g/mole”).

As used herein, the indication that a radical may be “optionally substituted” or “optionally further substituted” means, in general, unless further limited either explicitly or by the context of such reference, such radical may be substituted with one or more inorganic or organic substituent groups, for example, alkyl, alkenyl, aryl, arylalkyl, alkaryl, a hetero atom, or heterocyclyl, or with one or more functional groups capable of coordinating to metal ions, such as hydroxyl, carbonyl, carboxyl, amino, imino, amido, phosphonic acid, sulphonic acid, or arsenate, or inorganic and organic esters thereof, such as, for example, sulphate or phosphate, or salts thereof.

As used herein, “parts by weight” or “pbw” in reference to a named compound refers to the amount of the named compound, exclusive, for example, of any associated solvent. In some instances, the trade name of the commercial source of the compound is also given, typically in parentheses. For example, a reference to “10 pbw cocoamidopropylbetaine (“CAPB”, as MIRATAINE BET C-30)” means 10 pbw of the actual betaine compound, added in the form of a commercially available aqueous solution of the betaine compound having the trade name “MIRATAINE BET C-30”, and exclusive of the water contained in the aqueous solution.

As used herein, an indication that a composition is “substantially free” of a specific material, means the composition contains no more than an insubstantial amount of that material, and an “insubstantial amount” means an amount that does not measurably affect the desired properties of the composition.

As used herein, the term “surfactant” means a compound that reduces surface tension when dissolved in water.

“Surfactant effective amount” means the amount of the surfactant that provides a surfactant effect to enhance the stability of emulsions of the polymers.

In one embodiment, described herein are dispersant of a mixture of unsaturated copolymerizable monomers.

Sorbitan esters and sorbitol esters, more typically sorbitan alkyl esters, which are, typically referred to as “Span” surfactants, and include, for example, sorbitan monolaurate (Span 20), sorbitan monopalmitate (Span 40), sorbitan tristearate (Span 65), sorbitan monooleate (Span 80), and alkoxylated sorbitan esters and alkoxylated sorbitol esters, more typically alkoxylated sorbitan alkyl esters, which are typically referred to as “tween” or “polysorbate” surfactants such as, for example, polyoxyethylene (20) sorbitan monolaurate (Tween 20 or Polysorbate 20), polyoxyethylene (20) sorbitan monopalmitate (Tween 40 or Polysorbate 40) polyoxyethylene (20) sorbitan monostearate (Tween 60 or Polysorbate 60), polyoxyethylene (20) sorbitan monooleate (Tween 80 or Polysorbate 80), and polyoxyethylene (20) sorbitan trioleate (Tween 85 or Polysorbate 85).

Pigments can be organic or non-organic. Organic color pigments include but are not limited to, for example: Monoazo pigments: (C.I. Pigment Yellow 1, 3, 62, 65, 73, 74, 97, 120, 151, 154, 168, 181, 183 and 191, C.I. Pigment Brown 25; C.I. Pigment Orange 5, 13, 36, 38, 64 and 67; C.I. Pigment Red 1, 2, 3, 4, 5, 8, 9, 12, 17, 22, 23, 31, 48:1, 48:2, 48:3, 48:4, 49, 49:1, 51:1, 52:1, 52:2, 53, 53:1, 53:3, 57:1, 58:2, 58:4, 63, 112, 146, 148, 170, 175, 184, 185, 187, 188, 191:1, 208, 210, 245, 247 and 251; C.I. Pigment Violet 32); Diazo pigments: (C.I. Pigment Orange 16, 34, 44 and 72; C.I. Pigment Yellow 12, 13, 14, 16, 17, 81, 83, 106, 113, 126, 127, 155, 174, 176 and 188; Diazo condensation pigments: C.I. Pigment Yellow 93, 95 and 128; pigments: C.I. Pigment Red 144, 166, 214, 220, 221, 242 and 262; C.I. Pigment Brown 23 and 41); Anthanthrone pigments: (C.I. Pigment Red 168); Anthraquinone pigments: (C.I. Pigment Yellow 147, 177 and 199; C.I. Pigment Violet 31); Anthrapyrimidine pigments: (C.I. Pigment Yellow 108); Quinacridone pigments: (C.I. Pigment Orange 48 and 49; C.I. Pigment Red 122, 202, 206 and 209; C.I. Pigment Violet 19); Quinophthalone pigments: (C.I. Pigment Yellow 138); Diketopyrrolopyrrole pigments: (C.I. Pigment Orange 71, 73 and 81; C.I. Pigment Red 254, 255, 264, 270 and 272); Dioxazine pigments: (C.I. Pigment Violet 23 and 37; C.I. Pigment Blue 80; flavanthrone pigments: C.I. Pigment Yellow 24); Indanthrone pigments: (C.I. Pigment Blue 60 and 64); Isoindoline pigments: (C.I. Pigments Orange 61 and 69; C.I. Pigment Red 260; C.I. Pigment Yellow 139 and 185); Isoindolinone pigments: (C.I. Pigment Yellow 109, 110 and 173); Isoviolanthrone pigments: (C.I. Pigment Violet 31); Metal complex pigments: (C.I. Pigment Red 257; C.I. Pigment Yellow 117, 129, 150, 153 and 177; C.I. Pigment Green 8); Perinone pigments: (C.I. Pigment Orange 43; C.I. Pigment Red 194); Perylene pigments: (C.I. Pigment Black 31 and 32; C.I. Pigment Red 123, 149, 178, 179, 190 and 224; C.I. Pigment Violet 29); Phthalocyanine pigments: (C.I. Pigment Blue 15, 15:1, 15:2, 15:3, 15:4, 15:6 and 16; C.I. Pigment Green 7 and 36); Pyranthrone pigments: (C.I. Pigment Orange 51; C.I. Pigment Red 216); Pyrazoloquinazolone pigments: (C.I. Pigment Orange 67; C.I. Pigment Red 251); Thio indigo pigments: (C.I. Pigment Red 88 and 181; C.I. Pigment Violet 38); Triarylcarbonium pigments: (C.I. Pigment Blue 1, 61 and 62; C.I. Pigment Green 1; C.I. Pigment Red 81, 81:1 and 169; C.I. Pigment Violet 1, 2, 3 and 27; C.I. Pigment Black 1 (aniline black); C.I. Pigment Yellow 101 (aldazine yellow); C.I. Pigment Brown 22. Non-Organic non-color pigments include but are not limited to, for example: white pigments: titanium dioxide (C.I. Pigment White 6), zinc white, pigment grade zinc oxide; zinc sulphide, lithopone; Black pigments: iron oxide black (C.I. Pigment Black 11), iron manganese black, spinel black (C.I. Pigment Black 27); carbon black (C.I. Pigment Black 7). Non-Organic color pigments include but are not limited to, for example: Chromatic pigments: chromium oxide, chromium oxide hydrate green; chrome green (C.I. Pigment Green 48); cobalt green (C.I. Pigment Green 50); ultramarine green; cobalt blue (C.I. Pigment Blue 28 and 36; C.I. Pigment Blue 72); ultramarine blue; manganese blue; ultramarine violet; cobalt violet; manganese violet; red iron oxide (C.I. Pigment Red 101); cadmium sulfoselenide (C.I. Pigment Red 108); cerium sulphide (C.I. Pigment Red 265); molybdate red (C.I. Pigment Red 104); ultramarine red; brown iron oxide (C.I. Pigment Brown 6 and 7), mixed brown, spinel phases and corundum phases (C.I. Pigment Brown 29, 31, 33, 34, 35, 37, 39 and 40), chromium titanium yellow (C.I. Pigment Brown 24), chrome orange; cerium sulphide (C.I. Pigment Orange 75); yellow iron oxide (C.I. Pigment Yellow 42); nickel titanium yellow (C.I. Pigment Yellow 53; C.I. Pigment Yellow 157, 158, 159, 160, 161, 162, 163, 164 and 189); chrlow 37 and 35); chrome yellow (C.I. Pigment Yellow 34); bismuth vanidate (C.I. Pigment Yellow 184).

In some embodiments, alcohol alkoxylate surfactant is of formula (I):

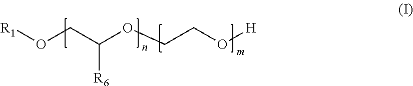

wherein R₆ comprises CH₃ or C₂H₅; “n” is an integer ranging from about 1 to about 30; and “m” is an integer ranging from 1 to about 30; and “p” is an integer ranging from 0 to about 20; wherein the sum of “n” and “m” equals from 4 to 50, typically from 6 to 30. In one embodiment, n+m=an integer ranging from 6 to 30. The alcohol alkoxylate is preferably in liquid form. In one embodiment, n+m=an integer ranging from 5 to 35. In one embodiment, n+m=an integer ranging from 7 to 30. In one embodiment, n+m=an integer ranging from 10 to 30. In one embodiment, n+m=an integer ranging from 10 to 20. While not being bound to theory, it is believed that the ratio of ethoxy to propoxy (or butoxy) groups allow for the compound to remain in liquid form, which is preferred under the present invention.

R₁, in one embodiment is a linear or branched C₄-C₂₀ alkyl or alkenyl group. R₁, in another embodiment is a linear or branched C₆-C₁₈ alkyl or alkenyl group. R₁, in yet another embodiment is a linear or branched C₇-C₁₈ alkyl or alkenyl group. In another embodiment, R₁ is a linear or branched C₈-C₁₈ alkyl or alkenyl group. R₁, in yet another embodiment is a linear or branched C₉-C₁₈ alkyl or alkenyl group. R₁, in yet another embodiment is a linear or branched C₁₀-C₁₈ alkyl or alkenyl group. R₁, in yet another embodiment is a linear or branched C₁₂-C₁₈ alkyl or alkenyl group.

R₁, in another embodiment is a linear or branched C₆-C₁₆ alkyl or alkenyl group. R₁, in yet another embodiment is a linear or branched C₆-C₁₄ alkyl or alkenyl group. R₁, in yet another embodiment is a linear or branched C₆-C₁₂ alkyl or alkenyl group. R₁, in yet another embodiment is a linear or branched C₆-C₁₀ alkyl or alkenyl group.

R₁, in yet another embodiment is a linear or branched C₈-C₁₆ alkyl or alkenyl group. R₁, in another embodiment, is a linear or branched C₉-C₁₄ alkyl or alkenyl group. R₁, in yet another embodiment is a linear or branched C₁₀-C₁₄ alkyl or alkenyl group.

In some embodiments, the ratio of “m” to “n” (m:n) is from 1:3 to 3:1, respectively. In some embodiments, the ratio of “m” to “n” (m:n) is from 1:4 to 4:1, respectively. In some embodiments, the ratio of m:n is less than or equal to 4:1. In some embodiments, the ratio of m:n is less than or equal to 3:1. While not being bound to theory, it is believed that the ratio of ethoxy to propoxy (or butoxy) groups allow for the compound to remain in liquid form, which is needed under the present invention. R₁ is previously defined herein.

In some embodiments, the alcohol alkoxylate surfactant is of formula (II):

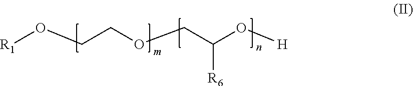

wherein R₆ comprises CH₃ or C₂H₅; “n” is an integer ranging from about 1 to about 30; and “m” is an integer ranging from 1 to about 30; and “p” is an integer ranging from 0 to about 20; wherein the sum of “n” and “m” equals from 4 to 50, typically from 6 to 30. In one embodiment, n+m=an integer ranging from 6 to 30. In one embodiment, n+m=an integer ranging from 5 to 35. In one embodiment, n+m=an integer ranging from 7 to 30. In one embodiment, n+m=an integer ranging from 10 to 30. In one embodiment, n+m=an integer ranging from 10 to 20.

In some embodiments, the ratio of “m” to “n” (m:n) is from 1:3 to 3:1, respectively. In some embodiments, the ratio of m:n is less than or equal to 4:1. In some embodiments, the ratio of m:n is less than or equal to 3:1.

The bivalent polyether group can comprise, in one embodiment, a linear chain of from 2 to 100 units, typically from 2 to 60 units, more typically from 2 to 30 units, which may be arranged alternately, randomly, or in blocks. In one embodiment, the alkoxylate units (e.g., oxyethylene units and oxypropylene units, and/or oxybutylene units of the polyether group are arranged in random sequence. In one embodiment, the alkoxylate units (e.g., oxyethylene units and oxypropylene units, and/or oxybutylene units of the polyether group are arranged in alternating sequence. In another embodiment, the alkoxylate units (e.g., oxyethylene units and oxypropylene units, and/or oxybutylene units of the polyether group are arranged in block sequence.

In some embodiments, the alcohol alkoxylate dispersant is of formula (III):

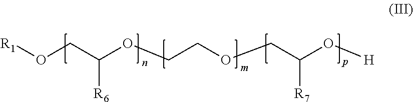

wherein R₆ and R₇ comprise, individually, CH₃ or C₂H₅; “n” is an integer ranging from about 0 to about 30; and “m” is an integer ranging from 1 to about 30; and “p” is an integer ranging from 0 to about 20; wherein the sum of “n”, “m” and “p” equals an integer of from 4 to 60, typically from 6 to 30; wherein at least one of “n” or “p” is present. In one embodiment, (“n” or “p”)+“m”=an integer ranging from 6 to 30. In one embodiment, (“n” or “p”)+“m”=an integer ranging from 5 to 35. In one embodiment, (“n” or “p”)+“m”=an integer ranging from 7 to 30. In one embodiment, (“n” or “p”)+“m”=an integer ranging from 10 to 30. In one embodiment, (“n” or “p”)+“m”=an integer ranging from 10 to 20. While not being bound to theory, it is believed that the ratio of ethoxy to propoxy (or butoxy) groups allow for the compound to remain in liquid form, which is needed under the present invention.

In some embodiments, the first dispersing aid is of formula (IV):

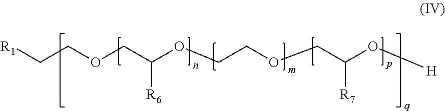

wherein R₆ and R₇ comprise, individually, CH₃ or C₂H₅; “n” is an integer ranging from about 1 to about 30; and “m” is an integer ranging from 1 to about 30; and “p” is an integer ranging from 0 to about 20; wherein the sum of “n”, “m” and “p” equals an integer of from 4 to 60, typically from 6 to 30; wherein “q” is an integer ranging from 1 to 3. In one embodiment, n+m=an integer ranging from 6 to 30. In one embodiment, n+m=an integer ranging from 5 to 35. In one embodiment, n+m=an integer ranging from 7 to 30. In one embodiment, n+m=an integer ranging from 10 to 30. In one embodiment, n+m=an integer ranging from 10 to 20. In one embodiment, R₁ is a linear or branched C₃-C₂₀ alkyl or alkenyl group. In one embodiment, R₁ is a linear or branched C₂-C₂₀ alkyl or alkenyl group. While not being bound to theory, it is believed that the ratio of ethoxy to propoxy (or butoxy) groups allow for the compound to remain in liquid form, which is needed under the present invention.

In some embodiments, the first dispersing aid is of formula (V):

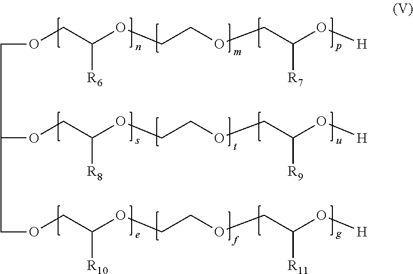

wherein each of R₆, R₇, R₈, R₉, R₁₀, R₁₁ comprise, individually, CH₃ or C₂H₅; wherein “n” is an integer ranging from about 0 to about 30; wherein “s” is an integer ranging from about 0 to about 30; wherein “e” is an integer ranging from about 0 to about 30; wherein “m” is an integer ranging from 1 to about 30; wherein “t” is an integer ranging from 1 to about 30; wherein “f” is an integer ranging from 1 to about 30; wherein “p” is an integer ranging from 0 to about 20; wherein “u” is an integer ranging from 0 to about 20; wherein “g” is an integer ranging from 0 to about 20; wherein at least one of “n” or “p” is present; wherein at least one of “s” or “u” is present; wherein at least one of “e” or “g” is present; wherein the sum of the presented “n”, “m” and “p” equals an integer of from 3 to 60; wherein the sum of the presented “s”, “t” and “u” equals an integer of from 3 to 60; wherein the sum of the presented “e”, “f” and “g” equals an integer of from 3 to 60.

R₁, in one embodiment is a linear or branched C₃-C₂₀ alkyl or alkenyl group. R₁, in one embodiment is a linear or branched C₄-C₂₀ alkyl or alkenyl group. R₁, in another embodiment is a linear or branched C₆-C₁₈ alkyl or alkenyl group. R₁, in yet another embodiment is a linear or branched C₇-C₁₈ alkyl or alkenyl group. In another embodiment, R₁ is a linear or branched C₈-C₁₈ alkyl or alkenyl group. R₁, in yet another embodiment is a linear or branched C₉-C₁₈ alkyl or alkenyl group. R₁, in yet another embodiment is a linear or branched C₁₀-C₁₈ alkyl or alkenyl group. R₁, in yet another embodiment is a linear or branched C₁₂-C₁₈ alkyl or alkenyl group.

R₁, in another embodiment is a linear or branched C₆-C₁₆ alkyl or alkenyl group. R₁, in yet another embodiment is a linear or branched C₆-C₁₄ alkyl or alkenyl group. R₁, in yet another embodiment is a linear or branched C₆-C₁₂ alkyl or alkenyl group. R₁, in yet another embodiment is a linear or branched C₆-C₁₀ alkyl or alkenyl group.

R₁, in yet another embodiment is a linear or branched C₈-C₁₆ alkyl or alkenyl group. R₁, in another embodiment, is a linear or branched C₉-C₁₄ alkyl or alkenyl group. R₁, in yet another embodiment is a linear or branched C₁₀-C₁₄ alkyl or alkenyl group.

In some embodiments, the ratio of “m” to “n+p” (m:(n+p)) is from 1:3 to 3:1, respectively. In some embodiments, the ratio of “m” to “n+p” (m:(n+p)) is from 1:9 to 9:1, respectively. In some embodiments, the ratio of “m” to “n+p” (m:(n+p)) is from 1:8 to 8:1, respectively. In some embodiments, the ratio of “m” to “n+p” (m:(n+p)) is from 1:5 to 5:1, respectively. In some embodiments, the ratio of m:(n+p) is less than or equal to 4:1. In some embodiments, the ratio of m:(n+p) is less than or equal to 3:1.

In one embodiment, the alcohol alkoxylate or dispersing aid has a Weight Average Molecular Weight (Mw) of 200 to 25,000 g/mole. In yet another embodiment, the alcohol alkoxylate has a Mw of 200 to 15,000 g/mole. In yet another embodiment, the alcohol alkoxylate has a Mw of 200 to 5,000 g/mole. In yet another embodiment, the alcohol alkoxylate has a Mw of 300 to 5,000.

In one embodiment, the dispersant for use in the present invention exhibit a weight average molecular weight, as determined by gel permeation chromatography and light scattering of a solution of the polymer in tetrahydrofuran and compared to a polystyrene standard, of less than 15,000 grams per mole (“g/mole”). In another embodiment, the polymeric dispersant polymers for use in the present invention exhibit a weight average molecular weight of less than 13,000 g/mole. In another embodiment, the polymeric dispersant polymers for use in the present invention exhibit a weight average molecular weight of less than 10,000 g/mole. In another embodiment, the polymeric dispersant polymers for use in the present invention exhibit a weight average molecular weight of less than 5,000 g/mole. In another embodiment, the polymeric dispersant polymers for use in the present invention exhibit a weight average molecular weight of less than 3,000 g/mole.

In one embodiment, the dispersant is in liquid form, and contains no or minimal solids. In one embodiment, the dispersant is in liquid form. In one embodiment, the colorant system composition is free of water

In another embodiment, the compositions as described herein are free of water, meaning water has been added to the composition. In another embodiment, the compositions as described herein are substantially free of water.

It is understood that while no water is added to the composition, moisture content in the composition (due to the surrounding atmosphere and conditions) can, in some embodiment, reach an amount of up to 0.5 wt % by weight of composition. In other embodiments, the moisture content can reach an amount of up to 0.1 wt % by weight of composition, while in other embodiments; the moisture content can reach an amount of up to 0.8 wt % by weight of composition. In further embodiments, the moisture content can reach an amount of up to 1 wt % by weight of composition, while in other embodiments, the moisture content can reach an amount of up to 2 wt % by weight of composition, and finally in other embodiments, the moisture content can reach an amount of up to 3 wt % by weight of composition.

In other embodiments, methods of tinting an alkyd-based base coating or a latex-based base coating are disclosed. Such methods comprise contacting an alkyd-based base coating or a latex-based base coating with a colorant system composition comprising: —a colorant component; —a first dispersing aid of formula (III) or formula (iv) or formula (v); and, optionally, at least one second dispersing aid; wherein the colorant system composition is compatible with both latex-based coatings and alkyd-based coatings.

Other dispersants can also be utilized in compositions described herein. Polymeric dispersants, for example, can be added as at least one second dispersant.

In one embodiment a polymeric dispersant is described as related to a monomeric unit comprising said polymeric dispersant, and then as a copolymer/polymer describing said polymeric dispersant.

Described herein are unsaturated monomers according to structure (D.I):

R¹⁸—R¹⁴—R¹³—R¹²—R¹¹ (D.I).

R¹² is absent or is a bivalent linking group,
R¹³ is bivalent polyether group,
R¹⁴ is absent or is a bivalent linking group;
R¹⁸ is a moiety having a site of ethylenic unsaturation; and
R¹¹ is according to structure D.XII

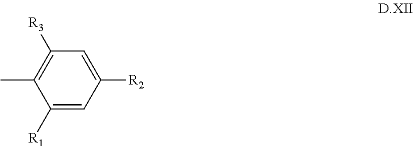

wherein R₁, R₂ and R₃ are independently selected from H, any of following structures D.XIIa, D.XIIb, D.XIIc, D.XIId:

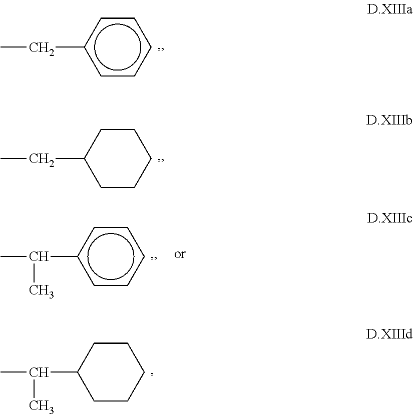

or a C₂-C₃₀ branched or linear alkyl group or alkenyl group;

wherein at least one of R₁, R₂ and R₃ is the C₂-C₃₀ branched or linear alkyl group or alkenyl group, and at least one of R₁, R₂ and R₃ is selected from structure D.XIIa, D.XIIb, D.XIIc, or D.XIId.

The polyether group, in one embodiment, comprises a chain of from 2 to 100 polymerized oxyethylene units and oxypropylene units, which may be arranged alternately, randomly, or in blocks. In one embodiment, R¹³ is a bivalent polyether group comprising a block of oxyethylene units and a block of oxypropylene units, more typically, a block of oxyethylene units and a block of oxypropylene units, wherein the block of oxypropylene units is disposed between and links the block of oxyethylene units. In some embodiments, the ratio of oxyethylene units to oxypropylene units is from 1:3 to 3:1, respectively. In some embodiments, the ratio of oxyethylene units to oxypropylene units is less than or equal to 4:1. In some embodiments, the ratio oxyethylene units to oxypropylene units is less than or equal to 3:1.

In another aspect, described herein are unsaturated monomers according to structure (D.I):

R¹⁸—R¹⁴—R¹³—R¹²—R¹¹ (D.I).

R¹² is absent or is a bivalent linking group,
R¹³ is bivalent polyether group,
R¹⁴ is absent or is a bivalent linking group;
R¹⁸ is a moiety having a site of ethylenic unsaturation; and
R¹¹ a tri-substituted aromatic group according to the structure D.XII

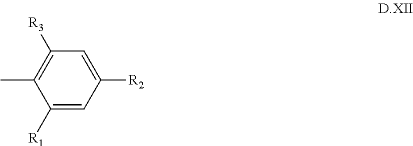

wherein R₁, R₂ and R₃ are independently selected from the following structures D.XIIa, D.XIIb, D.XIIc, D.XIId:

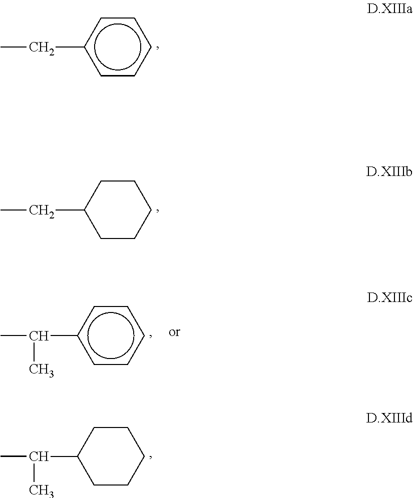

or a C₂-C₃₀ branched or linear alkyl group or alkenyl group;

wherein at least one of R₁, R₂ and R₃ is the C₂-C₃₀ branched or linear alkyl group or alkenyl group, and at least one of R₁, R₂ and R₃ is selected from structure D.XIIa, D.XIIb, D.XIIc, or D.XIId.

In one embodiment, R₁₂ is —(CH₂)ₓO —, wherein x is an integer from 1 to 20 (e.g., use of styrenated benzyl alcohols)

In another embodiment, R₁₂ is —CH₂CH(OH)CH₂O— or —CH₂CH(CH₂OH)O— (e.g., use of epichlorohydrin as coupling agent)

In one embodiment, R₁₃ is:

[CH(R₂₀)CH(R₂₁)O]ₓ— wherein x is an integer of from 0 to 100, and R₂₀ and R₂₁ are independently selected from any of the following:

H; —CH₂OH; phenyl; —CH₂Cl;

a C₁-C₃₀ straight or branched alkyl or alkenyl;

—CH₂OR₂₂ wherein R₂₂ is C₁-C₃₀ straight or branched alkyl or alkenyl, phenyl, or alkyl substituted phenyl; or

R′COOCH₂— where R′ is C₁-C₃₀ straight or branched alkyl or alkenyl.

In another aspect, the invention is directed to polymeric dispersant (co)polymer of a mixture of unsaturated copolymerizable monomers, the unsaturated copolymerizable monomers comprising, based on total weight of monomers:

A. about 0 to 60 weight percent, preferably 5 to 30 weight percent or 10 to 45 weight percent, of at least one C₃-C₈ alpha beta-ethylenically unsaturated acidic monomer, preferably a C₃-C₈ alpha beta-ethylenically unsaturated carboxylic acid monomer;

B. about 15 to 70 weight percent, typically 20 to 50 weight percent, of at least one non-ionic, copolymerizable C₂-C₁₂ alpha, beta-ethylenically unsaturated monomer; and

C. about 0.01 to 50 weight percent (wt %), or in another embodiment 0.05 to 30 weight percent, or in another embodiment 0.5 to 10 weight percent, or in another embodiment 1 to 10 weight percent, or in another embodiment 0.5 to 9 weight percent, or in another embodiment 0.5 to 7 weight percent, or in another embodiment 4 to 10 weight percent, of at least one non-ionic ethylenically unsaturated hydrophobic monomer as described herein.

The polymeric dispersant (co)polymer can, in one embodiment, be a homopolymer or, in another embodiment, be a copolymer comprising two or more different monomeric units.

The aqueous coating composition is a stable fluid that can be applied to a wide variety of materials such as, for example, paper, wood, concrete, metal, glass, ceramics, plastics, plaster, and roofing substrates such as asphaltic coatings, roofing felts, foamed polyurethane insulation; or to previously painted, primed, undercoated, worn, or weathered substrates. The aqueous coating composition of the invention can be applied to the materials by a variety of techniques well known in the art such as, for example, brush, rollers, mops, air-assisted or airless spray, electrostatic spray, and the like.

Other dispersant and/or additives can be utilized in the present invention, including but not limited to: methanol, ethanol, or propanol, (C₁-C₃)glycols, for example, ethylene glycol, or propylene glycol, and/or alkylether diols, for example, ethylene glycol monoethyl ether, propylene glycol monoethyl ether and diethylene glycol monomethyl ether. Other examples include, alkyl polyglycol ethers such as ethoxylation products of lauryl, tridecyl, oleyl, and stearyl alcohols; alkyl phenol polyglycol ethers such as ethoxylation products of octyl- or nonylphenol, diisopropyl phenol, triisopropyl phenol.

Suitable bicycloheptyl- and bicycloheptenyl-moieties may be derived from, for example, terpenic compounds having core (non-substituted) 7 carbon atom bicyclic ring systems according to structures (XII)-(XVII):

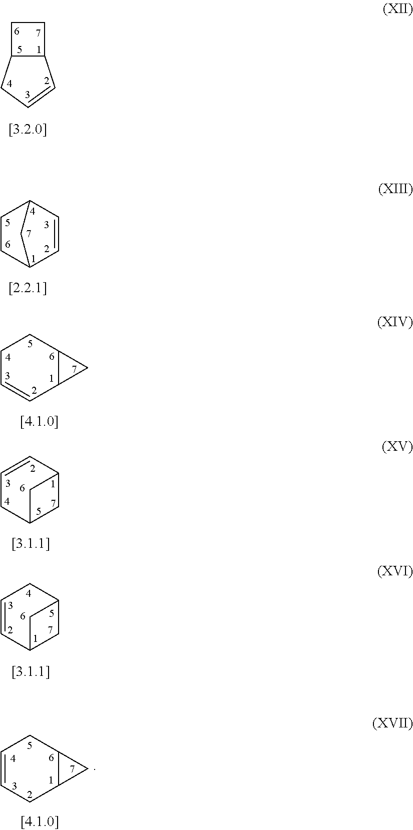 [SMILES: C1=CC2CCC2C1 ; C1=CC2CCC1C2 ; C1=CC2CC2CC1 ; C1=CC2CC(C1)C2 ; C1=CC2CC(C1)C2 ; C1=CCC2CC2C1]

For example, a bicycloheptenyl intermediate compound (XVIII), known as “Nopol”:

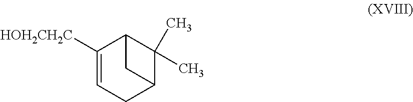

is made by reacting β-pinene with formaldehyde, and a bicycloheptyl intermediate compound (XIX), known as “Arbanol:

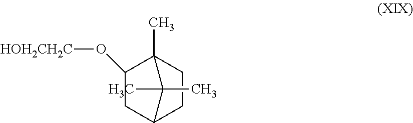

is made by isomerization of α-pinene to camphene and ethoxyhydroxylation of the camphene.

In one embodiment, the composition of the present invention comprises at least one dispersant and a liquid carrier.

In one embodiment, the liquid carrier comprises a water miscible organic liquid. Suitable water miscible organic liquids include saturated or unsaturated monohydric alcohols and polyhydric alcohols, such as, for example, methanol, ethanol, isopropanol, cetyl alcohol, benzyl alcohol, oleyl alcohol, 2-butoxyethanol, and ethylene glycol, as well as alkylether diols, such as, for example, ethylene glycol monoethyl ether, propylene glycol monoethyl ether and diethylene glycol monomethyl ether.

As used herein, terms “aqueous medium” and “aqueous media” are used herein to refer to any liquid medium of which water is a major component. Thus, the term includes water per se as well as aqueous solutions and dispersions.

The copolymer blends of the invention can be used in accordance with the prior art for known dispersants, using the dispersants according to the invention in place of their prior-art counterparts. Thus, for example, they can be used in the preparation or processing of paints, printing inks, inkjet inks, paper coatings, leather colors and textile colors, pastes, pigment concentrates, ceramics, cosmetic preparations, particularly if they contain solids such as pigments and/or fillers. They can also be employed in connection with the preparation or processing of casting and/or molding compounds based on synthetic, semi-synthetic or natural macromolecular compounds, such as polyvinyl chloride, saturated or unsaturated polyesters, polyurethanes, polystyrenes, polyacrylates, polyamides, epoxy resins, polyolefins such as polyethylene or polypropylene, for example. By way of example it is possible to use the copolymer blends for preparing casting compounds, PVC plastisols, gelcoats, polymer concrete, printed circuit boards, industrial paints, wood and furniture varnishes, vehicle finishes, marine paints, anti-corrosion paints, can coatings and coil coatings, decorating paints and architectural paints, where binders and/or solvents, pigments and optionally fillers, the copolymer blends, and typical auxiliaries are mixed. Examples of typical binders are resins based on polyurethanes, cellulose nitrates, cellulose acetobutyrates, alkyds, melamines, polyesters, chlorinated rubbers, epoxides and (meth)acrylates. Examples of water-based coatings are cathodic or anodic electrodeposition coatings for car bodies, for example. Further examples are renders, silicate paints, emulsion paints, aqueous paints based on water-thinnable alkyds, alkyd emulsions, hybrid systems, 2-component systems, polyurethane dispersions and acrylate dispersions.

Current comparisons are tested against a commercially available dispersant D23 (tri-styryl phenol ethoxylate—16 EO), as well as D24, an anionic phosphate ester. The new universal colorant shows improved color development and better rub-up performance when compared to the D23 and D24 in an aqueous paint formulation. In addition, unlike commercially available dispersants, it can be used in solvent based systems based on solubility testing results in low polarity to high polarity solvents (including but not limited to, e.g., xylene to isopropanol). The improved color development comes from better dispersing and wetting of the organic pigment while stabilizing the dispersions in various mediums.

As described above, latex paints and coatings may contain various adjuvants.

The aqueous coating compositions of the invention include less than 2% by weight and preferably less than 1.0% by weight of anti-freeze agents based on the total weight of the aqueous coating composition. For example, the aqueous coating compositions may be substantially free of anti-freeze agents.

The aqueous coating composition typically includes at least one pigment. The term “pigment” as used herein includes non-film-forming solids such as pigments, extenders, and fillers. The at least one pigment is preferably selected from the group consisting of TiO2 (in both anastase and rutile forms), clay (aluminum silicate), CaCO3 (in both ground and precipitated forms), aluminum oxide, silicon dioxide, magnesium oxide, talc (magnesium silicate), barytes (barium sulfate), zinc oxide, zinc sulfite, sodium oxide, potassium oxide and mixtures thereof. Suitable mixtures include blends of metal oxides such as those sold under the marks MINEX (oxides of silicon, aluminum, sodium and potassium commercially available from Unimin Specialty Minerals), CELITES (aluminum oxide and silicon dioxide commercially available from Celite Company), ATOMITES (commercially available from English China Clay International), carbon black, and ATTAGELS (commercially available from Engelhard). More preferably, the at least one pigment includes TiO2, CaCO3 or clay. Generally, the mean particle sizes of the pigments range from about 0.01 to about 50 microns. For example, the TiO2 particles used in the aqueous coating composition typically have a mean particle size of from about 0.15 to about 0.40 microns. The pigment can be added to the aqueous coating composition as a powder or in slurry form. The pigment is preferably present in the aqueous coating composition in an amount from about 5 to about 50 percent by weight, more preferably from about 10 to about 40 percent by weight.

The coating composition can optionally contain additives such as one or more film-forming aids or coalescing agents. Suitable firm-forming aids or coalescing agents include plasticizers and drying retarders such as high boiling point polar solvents. Other conventional coating additives such as, for example, dispersants, additional surfactants (i.e. wetting agents), rheology modifiers, defoamers, thickeners, additional biocides, additional mildewcides, colorants such as colored pigments and dyes, waxes, perfumes, co-solvents, and the like, can also be used in accordance with the invention. For example, non-ionic and/or ionic (e.g. anionic or cationic) surfactants can be used to produce the polymer latex. These additives are typically present in the aqueous coating composition in an amount from 0 to about 15% by weight, more preferably from about 1 to about 10% by weight based on the total weight of the coating composition.

The aqueous coating composition typically includes less than 10.0% of anti-freeze agents based on the total weight of the aqueous coating composition. Exemplary anti-freeze agents include ethylene glycol, diethylene glycol, propylene glycol, glycerol (1,2,3-trihydroxypropane), ethanol, methanol, 1-methoxy-2-propanol, 2-amino-2-methyl-1-propanol, and FTS-365 (a freeze-thaw stabilizer from Inovachem Specialty Chemicals). More preferably, the aqueous coating composition includes less than 5.0% or is substantially free (e.g. includes less than 0.1%) of anti-freeze agents. Accordingly, the aqueous coating composition of the invention preferably has a VOC level of less than about 100 g/L and more preferably less than or equal to about 50 g/L.

The balance of the aqueous coating composition of the invention is water. Although much of the water is present in the polymer latex dispersion and in other components of the aqueous coating composition, water is generally also added separately to the aqueous coating composition. Typically, the aqueous coating composition includes from about 10% to about 85% by weight and more preferably from about 35% to about 80% by weight water. Stated differently, the total solids content of the aqueous coating composition is typically from about 15% to about 90%, more preferably, from about 20% to about 65%.

The coating compositions are typically formulated such that the dried coatings comprise at least 10% by volume of dry polymer solids, and additionally 5 to 90% by volume of non-polymeric solids in the form of pigments. The dried coatings can also include additives such as plasticizers, dispersants, surfactants, rheology modifiers, defoamers, thickeners, additional biocides, additional mildewcides, colorants, waxes, and the like, that do not evaporate upon drying of the coating composition.

Experiments

Initial Experiments with Various Chemicals

Initial experimentation started with testing various samples to determine which had low viscosity when mixed with the phthalo blue 15:4 pigment, and relatively low particle size.

TABLE 1
Initial Samples

| Sample ID | Description |
|---|---|
| D1 | C8-10 molecule with 5 mol EO and 8 mol PO |
| D2 | C8-10 molecule with 5 mol EO and 4 mol PO |
| D3 | C12-16 molecule with 8.5 mol EO and 7 mol PO |
| D4 | C12-16 molecule with 6.4 mol EO and 10.1 mol PO |
| D5 | C7-9 molecule with 5.7 mol EO and 6 mol PO |
| D6 | C12 molecule with 6 mol EO and 7 mol PO |
| D7 | Octylphenol molecule with 9 mol EO |
| D8 | Nonylpenol molecule with 9 mol EO |
| D9 | Nopol with 6.5 mol EO and 18.5 mol PO |
| D10 | C13 molecule with 3 mol EO - |
| D11 | C13 molecule with 6 mol EO |
| D12 | C13 molecule with 7 mol EO |
| D13 | C13 molecule with 10 mol EO |
| D14 | C13 molecule with 15 mol EO |
| D15 | C10 molecule with 6 mol EO |
| D16 | Linear C10-16 molecule with 7 mol EO |
| D17 | Linear C12-15 molecule with 7 mol EO |
| D18 | TSP molecule with 10 mol EO |

Table 1 gives the samples used in the initial evaluations performed with dispersing phthalo blue 15:4.

Samples in Table 1 were then made into a dispersion with the following formulation:

Dispersant—100 grams

Phthalo Blue 15:4 pigment—50 grams

The samples were mixed at 1,000 cps on the high speed Dispermat for 30 minutes, then allowed to sit for 10 minutes to de-aerate.

As stated above, D23 is a TSP with 16 EO (Control), and D24 is an anionic phosphate ester

TABLE 2
Viscosity Results

| | | Amount | Amount | Viscosity | Viscosity |
|---|---|---|---|---|---|
| | | Dispersant | Pigment | @12 rpm | @60 rpm |
| Sample | Dispersant | (g) | (g) | (rpm) | (rpm) |
| S1 | D2 | 50 | 25 | 1650 | 819.8 |
| S2 | D9 | 50 | 25 | 3699 | 2340 |
| S3 | D18 | 50 | 25 | 34443 | EEEE |
| S4 | D3 | 50 | 25 | 2200 | 1260 |
| S5 | D6 | 50 | 25 | 1750 | 1050 |
| S6 | D11 | 50 | 25 | 16846 | 5299 |
| S7 | D13 | 50 | 25 | 35842 | EEEE |
| S8 | D8 | 50 | 25 | 26244 | EEEE |
| S9 | D1 | 50 | 25 | 2749 | 1400 |
| S10 | D10 | 50 | 25 | 22245 | 6229 |
| S11 | D15 | 50 | 25 | 30793 | 8969 |
| S12 | D7 | 50 | 25 | 14547 | 6959 |
| S13 | D12 | 50 | 25 | 17146 | 5159 |
| S14 | D4 | 50 | 25 | 3299 | 1510 |
| S15 | D5 | 35.5 | 17.8 | 3999 | 1820 |

Based on the dispersion samples shown in Table 2, the best performing dispersants for low viscosity dispersions were based on the EO/PO mixtures. In order to have a low viscosity, and mixture of ethylene oxide and propylene oxide had to be added to the chemical by ethoxylation. In the tables discussed herein, the result “EEEE” signifies that the results could not be measured (too viscous to be measured).

TABLE 2
Dispersants Tested

| Sample ID | Description |
|---|---|
| D19 | Lauryl alcohol with 4.5 mol EO and 7 mol PO |
| D20 | Diethylene glycol with 23 EO and 28 PO |
| D21 | Tridecyl/lauryl alcohol with 33 EO |
| D22 | Sorbitan monooleate with 20 mol EO |
| D23 | Tri-Styryl Phenol 16 EO, 0 PO |
| D24 | Anionic Phosphate Ester |

The following tables examined at other chemistries to determine if additional performance gains can be achieved.

TABLE 3
Second Round Viscosity Results

| | Samples | | | | | | | | | |
|---|---|---|---|---|---|---|---|---|---|---|
| Chemical | S-1217- | | S-1217- | S-1217- | S-1217- | | S-1217- | S-1217- | | S-1217- |
| Column1 | 33A | | 33B | 33C | 33D | | 33E | 33F | | 33G |
| DiH2O | 47.06 | g | | | | | | | | |
| D2 | | | 100 g | | 49.4 | g | 50 g | 43.4 | g | 50 g |
| D19 | | | | 100 g | 49.4 | g | 50 g | 43.4 | g | 50 g |
| D23 | 7.94 | g | | | | | | | | |
| D24 | | | | | 10 | g | | | | |
| D20 | | | | | | | 8.8 g | | | |
| D21 | | | | | | | | 22.0 | g | |
| D22 | | | | | | | | | | 8.8 g |
| Phthalo | 45 | g | 50 g | 50 g | 50 | g | 50 g | 50 | g | 50 g |
| Blue 15:4 | | | | | | | | | | |

Table 3 shows the results from testing various dispersants along with blends of dispersants. Comparisons were completed against commercial dispersants D23 and D24.

TABLE 4
Second Round Viscosity Results

| | Viscosity | Viscosity | Viscosity | Viscosity |
|---|---|---|---|---|
| | @12 rpm | @ 60 rpm | Milled @ | Milled at |
| Sample ID | (rpm) | (rpm) | 12 rpm (rpm) | 60 rpm (rpm) |
| 33A | 1100 | 569.9 | 2599 | 1320 |
| 33B | 2349 | 1080 | 40841 | EEEE |
| 33C | 2349 | 1130 | 28444 | 8518 |
| 33D | 2799 | 1180 | 22245 | 6009 |
| 33E | 1050 | 739.8 | 10348 | 3269 |
| 33F | 899.9 | 699.9 | 2749 | 1370 |
| 33G | 1450 | 809.8 | 11498 | 3249 |

Viscosity results showed that the sample with the commercial dispersant D23 had the lowest viscosity, followed by the sample with the mixture of D2, D19 and D21 dispersants. This result was unexpected due to the high amount of EO found in the aggregate.

TABLE 5
Color Development Results

| Sample | Color Strength (%) | ΔL | Δa | Δb |
|---|---|---|---|---|
| S1217-33A | 100.0 | 0.00 | 0.00 | 0.00 |
| S1217-33B | 120.5 | −1.08 | −1.81 | −2.28 |
| S1217-33C | 113.5 | −0.66 | −1.54 | −1.69 |
| S1217-33D | 109.9 | −0.19 | −1.64 | −1.48 |
| S1217-33E | 120.3 | −0.76 | −1.75 | −1.90 |
| S1217-33F | 121.0 | −1.72 | −1.44 | −1.93 |
| S1217-33G | 114.4 | −0.31 | −1.68 | −1.50 |

Samples of the dispersions were added in at to a latex acrylic paint, Behr Premium Plus #3052, at 4% on total weight. Paints were then mixed up on a Red Devil Paint Shaker for 30 minutes to fully disperse the dispersion.

Table 5 shows the differences in the color strength of the various paints when compared to the control (51217-33A). Surprisingly, all of the samples had better color development than the control. In addition, the S1217-33F sample had the best color strength and lowest Δb value in all the samples. This indicates that the sample has a greater bluish undertone than yellow undertone, providing a better overall color development for a blue paint.

Testing was completed to determine what the optimum level of mixture between the D2 and the D19 dispersant should be to improve viscosity while reducing particle size of the pigment after a dispersion has been made. Comparison to an existing commercial product was included.

TABLE 6
Variations in Dispersant Ratio

| | | | | | | | | | Amount | Amount | |
|---|---|---|---|---|---|---|---|---|---|---|---|
| | | | | | | | | | Phthalo | Stainless | Pigment/ |
| Sample | Amount | | Amount | | Amount | | | | Blue | Steel | Liquid |
| ID | D2 | | D19 | | D23 | | DiH2O | | 15:4 | Beads | Ratio |
| S-1217- | 100 | g | 0 | g | 0 | g | 0 | g | 50 g | 50 g | 0.50 |
| 28A | | | | | | | | | | | |
| S-1217- | 75 | g | 25 | g | 0 | g | 0 | g | 50 g | 50 g | 0.50 |
| 28B | | | | | | | | | | | |
| S-1217- | 50 | g | 50 | g | 0 | g | 0 | g | 50 g | 50 g | 0.50 |
| 28C | | | | | | | | | | | |
| S-1217- | 25 | g | 75 | g | 0 | g | 0 | g | 50 g | 50 g | 0.50 |
| 28D | | | | | | | | | | | |
| S-1217- | 0 | g | 100 | g | 0 | g | 0 | g | 50 g | 50 g | 0.50 |
| 28E | | | | | | | | | | | |
| S-1217- | 0 | g | 0 | g | 7.94 | g | 47.06 | g | 45 g | 50 g | 0.81 |
| 28F | | | | | | | | | | | |

Table 6 shows the ratios tested between D2 and D19 dispersants, as well as the control, D23, that was used.

TABLE 7
Viscosity Results from Formulations Found in Table 6

| | Viscosity | Viscosity | Viscosity | Viscosity |
|---|---|---|---|---|
| | @12 rpm | @ 60 rpm | Milled @ | Milled at |
| Sample ID | (rpm) | (rpm) | 12 rpm (rpm) | 60 rpm (rpm) |
| S-1217-28A | 2000 | 909.8 | 19569 | 6169 |
| S-1217-28B | 1400 | 749.8 | 22595 | 9448 |
| S-1217-28C | 1100 | 669.9 | 9448 | 3179 |
| S-1217-28D | 1150 | 749.8 | 7998 | 2439 |
| S-1217-28E | 899.8 | 679.9 | 6699 | 2489 |
| S-1217-28F | 1100 | 479.9 | 249.9 | 130 |

The viscosity results on the dispersions that were made in Table 6 are shown in Table 7. The samples with the greater amount of D19 showed lower viscosities than the samples with higher amounts of D2, but still not quite as fluid as the control. However, the control contains 47% water in the dispersion formulation, whereas the other dispersions are water and solvent free.

TABLE 8
Color Development Results

| | Sample ID | | | | | |
|---|---|---|---|---|---|---|
| | S-1217- | S-1217- | S-1217- | S-1217- | S-1217- | S-1217- |
| | 28A | 28B | 28C | 28D | 28E | 28F |
| Tint Base | 97.3 | 97.3 | 97.3 | 97.3 | 97.3 | 98 |
| level (g) | | | | | | |
| Colorant | 2.7 | 2.7 | 2.7 | 2.7 | 2.7 | 2 |
| Strength (g) | | | | | | |
| Tint | 132.08 | 124.53 | 123.9 | 125.8 | 117.72 | 100 |
| Strength (%) | | | | | | |
| L | 66.27 | 66.85 | 67.1 | 66.87 | 67.22 | 68.5 |
| a | −22.22 | −22.06 | −22.08 | −21.93 | −21.76 | −20.69 |
| B | −33.33 | −32.93 | −32.7 | −32.72 | −32.45 | −30.81 |
| ΔL | −2.21 | −1.6 | −1.43 | −1.71 | −1.23 | 0 |
| Δa | −1.53 | −1.44 | −1.54 | −1.44 | −1.07 | 0 |
| ΔB | −2.56 | −2.08 | −2.05 | −2.09 | −1.58 | 0 |
| ΔE | 3.7 | 2.99 | 2.93 | 3.08 | 2.24 | 0 |
| Rub Up | 1.14 | 1.48 | 1.45 | 1.39 | 1.7 | 3.34 |
| ΔE | | | | | | |

The color development results in Table 8 show a surprising increase in color development with the D2/D19 blended dispersants compared to the conventional dispersant. Samples were weighted out based on equivalent pigment loading so the same amount of pigment was added to the each sample of paint.

Not only was tint strength improved, but all the developmental samples had lower Δb values, indicating better blue tone in the paint. In addition, when doing Rub Up testing, the control had double the ΔE value than the developmental samples, indicating better pigment flow.

Unique to these developmental dispersants for universal colorants, they are soluble in a variety of solvents, ranging from highly polar to non-polar aromatic solvents.

TABLE 9
Solubility Chart

| Sample | Solvent | 1% | 5% | 10% |
|---|---|---|---|---|
| D2 | Xylene | Soluble | | Slightly |
| | | | | hazy |
| | Isopropanol | Soluble | | |
| | Acetone | Soluble | | |
| | MIAK | Soluble | | |
| | PM Acetate | Soluble | | |
| | Water | Soluble | | |
| D19 | Xylene | Slightly | Hazy | Miscible |
| | | soluble | | |
| | Isopropanol | Soluble | | |
| | Acetone | Soluble | | |
| | MIAK | Slightly | Soluble | |
| | | soluble | | |
| | PM Acetate | Soluble | | |
| | Water | Soluble | Slight Haze | Hazy |

| | | | |
|---|---|---|---|
| 50/50 Blend | xylene | Soluble | Slightly |
| D2/D19 | | | hazy |

| Isopropanol | Soluble | |
|---|---|---|
| Acetone | Soluble | |
| MIAK | Slightly | Soluble |
| | insoluble | |

| | |
|---|---|
| PM Acetate | Soluble |
| Water | Soluble |

Table 9 shows the solubility chart of both the separate component and the 50/50 blend of D2/D19 in various liquids. These developmental dispersants are usable in non-polar to highly-polar solvents, as well as water.

Blend of Dispersants with Polymerics

The second phase of the development of new dispersants included adding a solid polymeric dispersant to the D2/D19 blend. This would then be tested against conventional dispersants in color development tests.

TABLE 10
Polymeric Dispersants Evaluated

| Label of | |
|---|---|
| Dispersant | Dispersant Chemistry |
| PD-1 | Tristyrylphenol with 40 EO |
| PD-2 | Developmental sample - block copolymer dispersant |
| PD-3 | eicosa(propoxy)deca(ethoxy)diethylamine |
| PD-4 | Tristyrylphenol with 25 EO |
| PD-5 | Sodium polyacrylate |

Table 10 shows the polymeric dispersants used to test the performance of the novel blended D2/D19 dispersant. PD-3 is trademarked as Solsperse 24000 SC sold by Lubrizol. PD-1 and PD-4 are dispersants sold by Solvay (Princeton, N.J.).

TABLE 11
Initial Formulations with Polymerics

| | Formulations (grams) | | | | |
|---|---|---|---|---|---|
| | S1240- | S1240- | S1240- | S1240- | S-1240- |
| Chemical | 24A | 24B | 24C | 25A | 25B |
| D2 | 50.0 | 50.0 | 50.0 | 50.0 | 50.0 |
| PD-1 | 5.0 | xxx | xxx | xxx | xxx |
| PD-2 | xxx | 5.0 | xxx | xxx | xxx |
| PD-3 | xxx | xxx | 5.0 | xxx | xxx |
| PD-4 | xxx | xxx | xxx | 5.0 | xxx |
| PD-5 | xxx | xxx | xxx | xxx | 5.0 |
| D19 | 50.0 | 50.0 | 50.0 | 50.0 | 50.0 |
| Notes | | Insoluble, | | | Insoluble, |
| | | unable to | | | unable to |
| | | test | | | test |

The PD-2 and PD-5 samples were insoluble in the novel dispersant blend. However, the other polymerics were soluble either at room temperature, or when the temperature was heated up to 50° C. and mixed for 15 minutes. The experimental dispersants were then mixed in with phthalo blue 15:2 pigment to create a pigmented dispersion.

TABLE 12
Pigment Dispersions made with Polymerics

| | Formulations (grams) | | |
|---|---|---|---|
| | S1240- | S1240- | S1240- |
| Chemical | 25C | 25D | 25A |
| S1240-24A | 100.0 | xxx | xxx |
| S1240-24C | xxx | 100.0 | xxx |
| S1240-25A | xxx | xxx | 100.0 |
| Phthalo Blue | 50.0 | 50.0 | 50.0 |
| 15:4 | | | |

Pigment dispersions were developed from the initial dispersants seen in Table 11. The samples were prepared by adding the dispersants into a stainless steel beaker, mixing at 1500 rpm on a high speed Dispermat, then slowly adding the phthalo blue 15:4 to the mixing dispersant. Once all the pigment was added, the samples were then poured into a plastic container and stainless steel beads were added. The containers were closed and placed on a Red Devil paint shaker for 30 minutes to mill the pigment as small as possible.

Once the pigment dispersion was made, it was added to Behr Premium Plus latex acrylic paint in the following formulation:

TABLE 13
Paint Formulation

| Paint | Dispersion |
|---|---|
| 48 grams | 2 grams |

Once added, the paint was then mixed up on the Red Devil paint shaker for 30 minutes to fully disperse the pigment throughout the paint.

Once mixed, the paint was then allowed to de-aerate for 1 hour, then drawdowns were completed using a 3 mil drawdown bar. After allowing 24 hours to fully dry, the drawdowns were then tested for color development.

TABLE 14
Color Development Results

| | Formulations | | |
|---|---|---|---|
| | S1240- | S1240- | S1240- |
| Test | 25C | 25D | 25A |
| L | 67.81 | 69.85 | 67.81 |
| a* | 23.18 | 21.37 | 23.21 |
| b* | 31.24 | 28.54 | 31.24 |
| ΔL | −2.04 | Control | −2.04 |
| Δa* | −1.81 | Control | −1.75 |
| Δb* | −2.69 | Control | −2.59 |
| ΔE | 3.83 | Control | 3.67 |
| Tristimulus | 126.44 | 100 | 125.36 |
| Color | | | |
| Strength (%) | | | |

Results shown in Table 14 indicate that the two polymerics based on the Tristyrylphenol chemistry performed better than the sample with the commercially available Solsperse 24000. Color development was improved by at least 25% over the Solsperse with better blue tone.

However, the Solsperse 24000 SC dispersant is traditionally used only for high performance solvent based paint/coatings systems and typically does not work at all in waterborne paints. With the addition of the Solsperse 24000 to the D1/D19 blend, the polymeric dispersant was successfully used in a waterborne paint. This is another surprising discovery of the D2/D19 blend.

The next test involved adding the dispersions to a long-oil alkyd paint (100% solvent-based paint) to determine if the blended dispersions would have decent performance properties in a solvent-based system

TABLE 15
Color Development Results in Long-Oil Alkyd Paint

| | Formulations | | |
|---|---|---|---|
| | S1240- | S1240- | S1240- |
| Test | 25C | 25D | 25A |
| L | 75.24 | 73.68 | 75.82 |
| a* | −17.17 | −20.03 | −16.35 |
| b* | −21.59 | −24.38 | −20.8 |
| ΔL | 1.55 | Control | 2.13 |
| Δa* | 2.88 | Control | 3.68 |
| Δb* | 2.79 | Control | 3.57 |
| ΔE | 4.28 | Control | 5.55 |
| Tristimulus | 96.86 | 100 | 95.43 |
| Color | | | |
| Strength (%) | | | |

The results in Table 15 indicates that the paint sample with the Solsperse 24000 based dispersion performed slightly better than the other two, but all worked within a Solvent-based paint system. This indicates that the D1/D19 based blends, with the polymeric dispersants added to them allows for use in both aqueous and non-aqueous systems. The ability to be used in both aqueous and non-aqueous systems allows for a paint manufacturer to use one dispersion to be used for both systems, eliminating the need for separate systems for aqueous and non-aqueous paints.

Next examples show the results when tested in a waterborne latex acrylic Behr paint compared to the newest commercial dispersants with an untreated phthalo blue 15:2 pigment.

TABLE 16
Formulations with Phthalo Blue 15:2

| | Formulations | | | | |
|---|---|---|---|---|---|
| | S1240- | S1240- | S1240- | S1240- | S1240- |
| Chemicals | 48A | 48B | 48C | 48D | 48E |
| Water | xxx | xxx | 46.0 | 41.5 | xxx |
| | | | grams | grams | |
| S1240-24A | 100 | xxx | xxx | xxx | xxx |
| | grams | | | | |
| S1240-25A | xxx | 100 | xxx | xxx | xxx |
| | | grams | | | |
| Tego 755 W | xxx | xxx | 9 | xxx | xxx |
| | | | grams | | |
| Disperbyk 2015 | xxx | xxx | xxx | 13.5 | xxx |
| | | | | grams | |
| D1/D19 50/50 | xxx | xxx | xxx | xxx | 100 |
| blend | | | | | grams |
| Phthalo Blue | 34.65 | 36.56 | 34.21 | 45 | 44.10 |
| 15:2 | grams | grams | grams | grams | grams |
| Notes | | | Reacted | Reacted | |
| | | | with | with | |
| | | | pigment | pigment | |

In the formulations seen in Table 16, a lower amount of phthalo blue 15:2 was used due to an increase in viscosity much more rapidly than when observed with phthalo blue 15:4 pigment. Both of the commercial dispersants, the Tego 755W and the Disperbyk 2015 had reactions with the phthalo blue 15:2 pigment that was not seen with the experimental polymeric dispersants.

These dispersions were then added to the waterborne latex acrylic Behr paint in the following ratios (which are based on consistent amount of pigment in the paint):

TABLE 17
Dispersion Calculations

Formulation

| | S1240- | S1240- | S1240- | S1240- |
|---|---|---|---|---|
| Chemical | 51A | 51B | 51C | 51D |
| Behr 3052 | 47 | 47.1 | 48 | 47.5 |
| Paint | grams | grams | grams | grams |
| S1240-48A | 3.0 | xxx | xxx | xxx |
| | grams | | | |
| S1240-48B | xxx | 2.9 | xxx | xxx |
| | | grams | | |
| S1240-48C | xxx | xxx | 2.0 | xxx |
| | | | grams | |
| S1240-48E | xxx | xxx | xxx | 2.5 |
| | | | | grams |

Note that the paints shown in Table 17 are based on the amount of pigment added to the paint in a consistent manner. The paint, with dispersion, was mixed on the Red Devil paint shaker for 60 minutes, and then allowed to sit for 60 minutes before testing to allow for de-aeration of the paint.

TABLE 18
Color Development Results for Commercial Comparisons

Samples

| | S1240- | S1240- | S1240- | S1240- |
|---|---|---|---|---|
| Test | 51A | 51B | 51C | 51D |
| % Color | 105.49 | 105.12 | 100 | 101.73 |
| Strength | | | | |
| L | 62.69 | 62.83 | 64.81 | 64.04 |
| a | −15.67 | −15.63 | −15.23 | −15.53 |
| B | −35.11 | −34.98 | −32.85 | −33.8 |
| ΔL | −2.12 | −1.97 | xxx | −0.76 |
| Δa | −0.44 | −0.4 | xxx | −0.3 |
| ΔB | −2.26 | −2.13 | xxx | −0.94 |
| ΔE | 3.12 | 2.92 | xxx | 1.24 |

Table 18 shows the results of the color development testing on the paint samples. The dispersion with the Disperbyk 2015 was eliminated from testing due to a visible, and rapid, reaction of the dispersant with the untreated phthalo blue 15:2 pigment. The same type of reaction was observed with the Tego 755W dispersant, but not in as rapid a development, and testing continued with the Tego sample before the reaction was observed. Neither of the experimental polymeric dispersants showed reaction with the pigment.

All of the experimental dispersants, when added to the waterborne latex acrylic paint showed improved color development compared to the Tego dispersed paint. The experimental polymeric dispersants showed an improved color development compared to the blended experimental dispersant.

These results indicate a novel and unique chemistry that allows for use in both aqueous and non-aqueous systems while providing better color development compared to conventional dispersants and without any reactivity issues with untreated pigment.

It should be apparent embodiments other than those expressly described above come within the spirit and scope of the present invention. Thus, the present invention is not defined by the above description but by the claims appended hereto.

What is claimed is:

1. A colorant system composition comprising:
a colorant component;
a first dispersing aid of formula (IV): 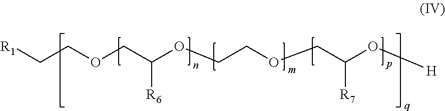
wherein R₆ and R₇ comprise, individually, CH₃ or C₂H₅;
wherein “n” is an integer ranging from about 0 to about 30;
wherein “m” is an integer ranging from 1 to about 30;
wherein “p” is an integer ranging from 0 to about 20;
wherein “q” is an integer ranging from 1 to 3;
wherein R₁ is a linear or branched C₂-C₂₀ alkyl or alkenyl group;
wherein at least one of “n” or “p” is present;
wherein the sum of the presented “n”, “m” and “p” equals an integer of from 4 to 60; and
wherein the first dispersing aid is in substantially liquid form; and
optionally, at least one second dispersing aid;
wherein the colorant system composition is compatible with both latex-based coatings and alkyd-based coatings.

2. The composition of claim 1 wherein the sum of the presented “n”, “m” and “p” equals an integer of from 6 to 30.

3. The composition of claim 1 wherein R₁ is a linear or branched C₃-C₁₈ alkyl or alkenyl group, or a linear or branched C₆-C₁₈ alkyl or alkenyl group, or a linear or branched C₁₀-C₁₈ alkyl or alkenyl group, or a linear or branched C₆-C₁₆ alkyl or alkenyl group, or a linear or branched C₆-C₁₄ alkyl or alkenyl group, or a linear or branched C₆-C₁₂ alkyl or alkenyl group.

4. The composition of claim 1 wherein the weight average molecular weight (Mw) of the first dispersing aid is from about 200 g/mole to about 25,000 g/mole.

5. The composition of claim 1 wherein the weight average molecular weight (Mw) of the first dispersing aid is from about 300 g/mole to about 10,000 g/mole.

6. The composition of claim 1 wherein the weight average molecular weight (Mw) of the first dispersing aid is from about 300 g/mole to about 5,000 g/mole.

7. The composition of claim 1 wherein the ratio of “m” to “n+p” (m:(n+p)) is from 1:9 to 9:1, respectively.

8. The composition of claim 1 wherein the ratio of “m” to “n+p” (m:(n+p)) is from 1:4 to 4:1, respectively.

9. The composition of claim 1 wherein the at least one second dispersing aid is least one of a polymeric dispersant, polycarboxylate, sodium polyacrylate, glycol, diethylene glycol, glycerine, C₆-C₁₈ alcohol ethoxylate and its sulfate or phosphate salts, sorbitan monoleate, tristyryl phenol ethoxylate, nopol-containing surfactant, or eicosa(propoxy)deca(ethoxy)diethylamine.

10. The composition of claim 1 wherein the composition is characterized by a VOC (Volatile Organic Content) of less than about 100 g/L.

11. The composition of claim 1 wherein the composition is characterized by a VOC (Volatile Organic Content) of less than about 60 g/L.

12. The composition of claim 1 wherein the composition is characterized by a VOC (Volatile Organic Content) of less than about 50 g/L.

13. A method of tinting an alkyd-based base coating or a latex-based base coating comprising contacting an alkyd-based base coating or a latex-based base coating with a colorant system composition comprising:
a colorant component;
a first dispersing aid of formula (IV): 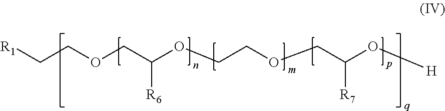
wherein R₆ and R₇ comprise, individually, CH₃ or C₂H₅;
wherein “n” is an integer ranging from about 0 to about 30;
wherein “m” is an integer ranging from 1 to about 30;
wherein “p” is an integer ranging from 0 to about 20;
wherein “q” is an integer ranging from 1 to 3;
wherein R₁ is a linear or branched C₂-C₂₀ alkyl or alkenyl group;
wherein at least one of “n” or “p” is present;
wherein the sum of the presented “n”, “m” and “p” equals an integer of from 4 to 60; and
wherein the first dispersing aid is in substantially liquid form; and
optionally, at least one second dispersing aid;
wherein the colorant system composition is compatible with both latex-based coatings and alkyd-based coatings.

14. The method of claim 13 wherein the sum of the presented “n”, “m” and “p” equals an integer of from 6 to 30.

15. The method of claim 13 wherein R₁ is a linear or branched C₃-C₁₈ alkyl or alkenyl group, or a linear or branched C₆-C₁₈ alkyl or alkenyl group, or a linear or branched C₁₀-C₁₈ alkyl or alkenyl group, or a linear or branched C₆-C₁₆ alkyl or alkenyl group, or a linear or branched C₆-C₁₄ alkyl or alkenyl group, or a linear or branched C₆-C₁₂ alkyl or alkenyl group.

16. The method of claim 13 wherein the weight average molecular weight (Mw) of the first dispersing aid is from about 300 g/mole to about 5,000 g/mole.

17. The method of claim 13 wherein the ratio of “m” to “n+p” (m:(n+p)) is from 1:3 to 3:1, respectively.

18. The method of claim 13 wherein the at least one second dispersing aid is at least one of a polymeric dispersant, polycarboxylate, sodium polyacrylate, glycol, diethylene glycol, glycerine, C₆-C₁₈ alcohol ethoxylate and its sulfate or phosphate salts, sorbitan monoleate, tristyryl phenol ethoxylate, nopol-containing surfactant, or eicosa(propoxy)deca(ethoxy)diethylamine.

19. The method of claim 13 wherein the composition is characterized by a VOC (Volatile Organic Content) of less than about 100 g/L.

20. The method of claim 13 wherein the composition is characterized by a VOC (Volatile Organic Content) of less than about 50 g/L.

21. A colorant system composition comprising:
a colorant component;
a first dispersing aid of formula (V): 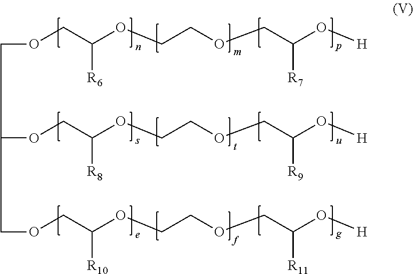
wherein each of R₆, R₇, R₈, R₉, R₁₀, R₁₁ comprise, individually, CH₃ or C₂H₅;
wherein “n” is an integer ranging from about 0 to about 30;
wherein “s” is an integer ranging from about 0 to about 30;
wherein “e” is an integer ranging from about 0 to about 30;
wherein “m” is an integer ranging from 1 to about 30;
wherein “t” is an integer ranging from 1 to about 30;
wherein “f” is an integer ranging from 1 to about 30;
wherein “p” is an integer ranging from 0 to about 20;
wherein “u” is an integer ranging from 0 to about 20;
wherein “g” is an integer ranging from 0 to about 20;
wherein at least one of “n” or “p” is present;
wherein at least one of “s” or “u” is present;
wherein at least one of “e” or “g” is present;
wherein the sum of the presented “n”, “m” and “p” equals an integer of from 3 to 60;
wherein the sum of the presented “s”, “t” and “u” equals an integer of from 3 to 60;
wherein the sum of the presented “e”, “f” and “g” equals an integer of from 3 to 60; and
wherein the first dispersing aid is in substantially liquid form; and
optionally, at least one second dispersing aid;
wherein the colorant system composition is compatible with both latex-based coatings and alkyd-based coatings.

22. A method of tinting an alkyd-based base coating or a latex-based base coating comprising contacting an alkyd-based base coating or a latex-based base coating with a colorant system composition comprising:
a colorant component;
a first dispersing aid of formula (V): 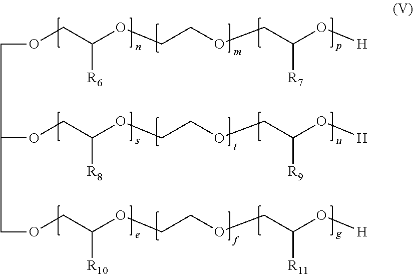
wherein each of R₆, R₇, R₈, R₉, R₁₀, R₁₁ comprise, individually, CH₃ or C₂H₅;
wherein “n” is an integer ranging from about 0 to about 30;
wherein “s” is an integer ranging from about 0 to about 30;
wherein “e” is an integer ranging from about 0 to about 30;
wherein “m” is an integer ranging from 1 to about 30;
wherein “t” is an integer ranging from 1 to about 30;
wherein “f” is an integer ranging from 1 to about 30;
wherein “p” is an integer ranging from 0 to about 20;
wherein “u” is an integer ranging from 0 to about 20;
wherein “g” is an integer ranging from 0 to about 20;
wherein at least one of “n” or “p” is present;
wherein at least one of “s” or “u” is present;
wherein at least one of “e” or “g” is present;
wherein the sum of the presented “n”, “m” and “p” equals an integer of from 3 to 60;
wherein the sum of the presented “s”, “t” and “u” equals an integer of from 3 to 60;
wherein the sum of the presented “e”, “f” and “g” equals an integer of from 3 to 60; and
wherein the first dispersing aid is in substantially liquid form; and
optionally, at least one second dispersing aid;
wherein the colorant system composition is compatible with both latex-based coatings and alkyd-based coatings.
